(19) United States
(12) Patent Application Publication
(10) Pub. No.: US 2012/0044693 A1
(43) Pub. Date: Feb. 23, 2012

(54) LASER LIGHT SOURCE APPARATUS

(75) Inventors: Yuichi HATASE, Kumamoto (JP); Kohei SUYAMA, Fukuoka (JP); Hirofumi ENOMOTO, Kumamoto (JP); Akinori OSADA, Fukuoka (JP); Yoshitaka KITAOKA, Kumamoto (JP)

(73) Assignee: PANASONIC CORPORATION, Osaka (JP)

(21) Appl. No.: 13/018,756

(22) Filed: Feb. 1, 2011

(30) Foreign Application Priority Data
Aug. 23, 2010 (JP) 2010-186234

(51) Int. Cl. G02B 27/20; F21V 21/00

(52) U.S. Cl. 362/259; 362/382

(57) ABSTRACT

In order to reduce manufacturing cost of a base supporting a semiconductor laser, without deteriorating accuracy of mounting of the semiconductor laser, a mounting member is provided between the base supporting the semiconductor laser and the semiconductor laser; and the semiconductor laser and the base are fixedly attached with heat-cured silver paste. The silver paste has a lower curing temperature than an assurance temperature of the semiconductor laser, and a higher heat resistance than an operation temperature of the semiconductor laser. The mounting member is formed of a material having a higher heat resistance than the curing temperature of the silver paste.

### CROSS-REFERENCE TO RELATED APPLICATIONS

The present application claims priority under 35 U.S.C. §119 of Japanese Application No. 2010-186234 filed on Aug. 23, 2010, the disclosure of which is expressly incorporated by reference herein in its entirety.

### BACKGROUND OF THE INVENTION

1. Field of the Invention

The present invention relates to a laser light source apparatus using a semiconductor laser, specifically a laser light source apparatus used as a light source of an image display apparatus.

2. Description of Related Art

Technology recently drawing attention employs a semiconductor laser as a light source of an image display apparatus. Compared with mercury lamps conventionally widely used in image display apparatuses, the semiconductor laser has a variety of advantages, including good color reproducibility, instant light up, long life, high efficiency and reduction in power consumption, and easy downsizing.

For such a laser light source apparatus used in an image display apparatus, there is no high-power semiconductor laser directly emitting green color laser light. Technology is thus known in which excitation laser light is output from a semiconductor laser; a laser medium is excited by the excitation laser light, so that infrared laser light is output; and a wavelength of the infrared laser light is converted by a wavelength conversion element, so that green color laser light is output. Such a technology is disclosed in Japanese Patent Laid-open Publication No. 2008-16833, for example.

A green color laser light source apparatus having the configuration above has a variety of optical members, including a laser medium, a wavelength conversion element, and the like, in addition to a semiconductor laser. Thus, it is preferred that the optical members above be integrally supported by a base. Since the semiconductor laser is a very small component, however, it is difficult to screw and mount the semiconductor laser to the base. An adhesive agent is then used to fix the semiconductor laser to the base.

In the green color laser light source apparatus having the configuration above, the output of the semiconductor laser needs to be high due to conversion loss at the laser medium and the wavelength conversion element. Since the semiconductor laser accordingly generates heat substantially, it is important to take a heat dissipation measure. When a configuration is employed in which the heat generated at the semiconductor laser is dissipated toward the base, it is preferred to employ an adhesive agent having a low heat resistance, specifically silver paste, in order to increase the heat dissipation performance. In particular, heat-cured silver paste using epoxy resin, which has a high adhesiveness, is convenient in order to surely fix the semiconductor laser to the base.

A die-cast material excellent in mass production performance is preferred for the base. The die-cast material, however, has a low heat resistance. In the configuration in which heat-cured silver paste is used to fix the semiconductor laser to the base formed of the die-cast material, the base is exposed to a high temperature in a process of heat-curing the silver paste. Thus, the base is deformed, and accuracy of mounting of the semiconductor laser is deteriorated. The deterioration in accuracy of mounting of the semiconductor laser causes misalignment of an optical axis, thus leading to a situation in which laser light is not output appropriately. Such a situation needs to be avoided.

### SUMMARY OF THE INVENTION

The present invention is provided to address the above-described problems in the conventional technologies. A main advantage of the present invention is to provide a laser light source apparatus configured to reduce manufacturing cost of a base that supports a semiconductor laser, without deteriorating accuracy of mounting of the semiconductor laser. A further advantage of the present invention is to provide a laser light source apparatus providing high workability and improving efficiency of an assembly process. A further advantage of the present invention is to ensure high dimension accuracy and to enhance accuracy of mounting of a semiconductor laser. Furthermore, the present invention provides a laser light source apparatus relatively inexpensive, excellent in mass production performance, and reducing manufacturing cost. A further advantage of the present invention is to provide a laser light source apparatus allowing easy electric connection of a semiconductor laser. A further advantage of the present invention is to provide a laser light source apparatus outputting high-power green color laser light. In this case, output of a semiconductor laser needs to be high, in view of conversion loss at a laser medium and a wavelength conversion element, thus leading to large heat generation at the semiconductor. Employing a low heat resistant material for an adhesive material and an mounting member allows efficient heat dissipation.

In view of the above, the present invention provides a laser light source apparatus including a semiconductor laser emitting laser light; a base supporting the semiconductor laser; and a mounting member provided between the base and the semiconductor laser. In the laser light source apparatus, the semiconductor laser and the mounting member are fixedly attached by a thermally adhesive material; the adhesive material has a lower adhesion temperature than an assurance temperature of the semiconductor laser and a higher heat resistance than an operation temperature of the semiconductor laser; and the mounting member is formed of a material having a higher heat resistance than the adhesion temperature of the adhesive material.

Thereby, fixedly attaching the semiconductor laser and the mounting member by the adhesive material, and then mounting the mounting member on the base can prevent the base from being exposed to a high temperature in a process of fixedly attaching with the adhesive member. Thus, accuracy of mounting of the semiconductor laser can be prevented from being deteriorated. Further, the base can be formed of a die-cast material having a relatively low heat resistance. Since the die-cast material is relatively inexpensive and excellent in mass production performance, manufacturing cost can be reduced.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 is a schematic view of a configuration of an image display apparatus according to a present embodiment;

FIG. 2 is a schematic view illustrating a state of laser light in a green color laser light source apparatus according to the present embodiment;

FIG. 3 is a perspective view of the green color laser light source apparatus according to the present embodiment;

FIG. 4 is an exploded perspective view of a semiconductor laser, a mounting member, and a base in the green color laser light source apparatus according to the present embodiment;

FIG. 5 illustrates an assembly process of the semiconductor laser, the mounting member, and the base according to the present embodiment; and

FIG. 6 is a perspective view illustrating an example in which the image display apparatus according to the present embodiment is installed in a laptop information processing apparatus.

### DETAILED DESCRIPTION OF PREFERRED EMBODIMENTS

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description is taken with the drawings making apparent to those skilled in the art how the forms of the present invention may be embodied in practice.

The embodiments of the present invention are explained below with reference to the drawings.

### Embodiments

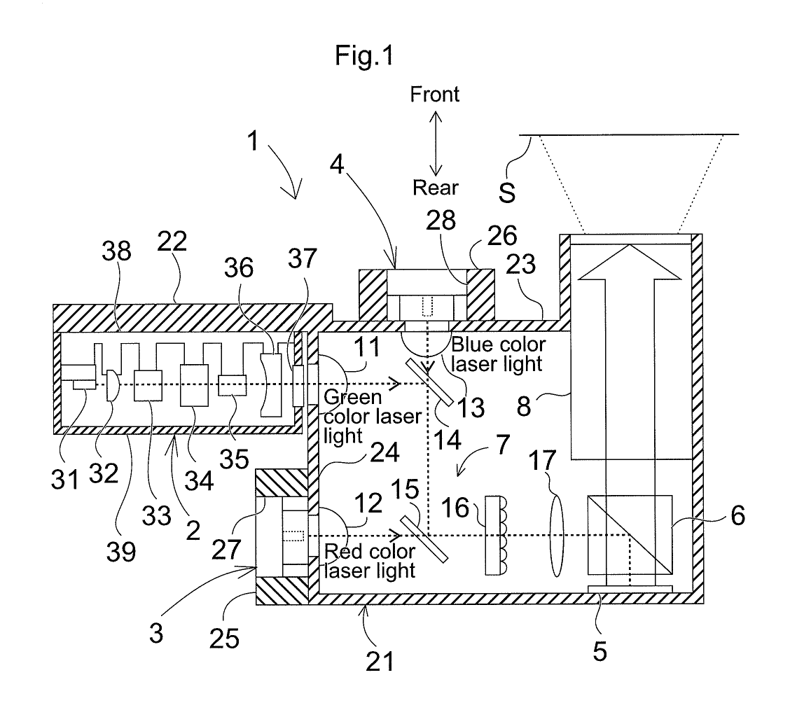

The embodiments of the present invention are explained below with reference to the drawings. FIG. 1 is a schematic view of a configuration of an image display apparatus 1 according to a present invention. The image display apparatus 1, which projects and displays a predetermined image on a screen, has a green color laser light source apparatus 2 emitting green color laser light; a red color laser light source apparatus 3 emitting red color laser light; a blue color laser light source apparatus 4 emitting blue color laser light; and an LCD-reflective spatial light modulator 5 modulating the laser light emitted from each of the laser light source apparatuses 2 to 4, according to an image signal; a polarization beam splitter 6 reflecting the laser light emitted from each of the laser light source apparatuses 2 to 4 and radiating the light onto the spatial light modulator 5, and transmitting the modulated laser light emitted from the spatial light modulator 5; a relay optical system 7 guiding the laser light emitted from each of the laser light source apparatuses 2 to 4 to the polarization beam splitter 6; and a projection optical system 8 projecting the modulated laser light that has transmitted the polarization beam splitter 6 on a screen.

The image display apparatus 1 displays a color image in a commonly-called field sequential system. Laser light having respective colors is sequentially emitted from the respective laser light source apparatus 2 to 4 on a time division basis. Images of the laser light having respective colors are recognized as a color image by a residual image.

The relay optical system 7 includes collimator lenses 11 to 13; a first dichroic mirror 14 and a second dichroic mirror 15; a diffuser panel 16; and a field lens 17. The collimator lenses 11 to 13 convert the laser light having respective colors into a parallel beam, the laser light being emitted from the respective laser light source apparatus 2 to 4. The first dichroic mirror 14 and the second dichroic mirror 15 guide the laser light in a predetermined direction, the laser light having passed through the collimator lenses 11 to 13. The diffuser panel 16 diffuses the laser light guided by the dichroic mirrors 14 and 15. The field lens 17 converts the laser light having passed through the diffuser panel 16 into a converging laser.

When a side on which the laser light is emitted from the projection optical system 8 toward the screen S is a front side, the blue color laser light is emitted rearward from the blue color laser light source apparatus 4. The green color laser light is emitted from the green color laser light source apparatus 2, and the red color laser light is emitted from the red color laser light source apparatus 3, such that an optical axis of the green color laser light and an optical axis of the red color laser light orthogonally intersect with an optical axis of the blue color laser light. The blue color laser light, the red color laser light, and the green color laser light are guided to a same optical path by the two dichroic mirrors 14 and 15. Specifically, the blue color laser light and the green color laser light are guided to the same optical path by the first dichroic mirror 14; and the blue color laser light, the green color laser light, and the red color laser light are guided to the same optical path by the second dichroic mirror 15.

Each of the first dichroic mirror 14 and the second dichroic mirror 15 is provided with a film on a surface thereof, the film transmitting and reflecting laser light having a predetermined wavelength. The first dichroic mirror 14 transmits the blue color laser light and reflects the green color laser light. The second dichroic mirror 15 transmits the red color laser light and reflects the blue color laser light and the green color laser light.

The optical members above are supported by a case 21. The case 21 functions as a heat dissipating body dissipating heat generated at the laser light source apparatuses 2 to 4. The case 21 is formed of a high thermal conductive material, such as aluminum and copper.

The green color laser light source apparatus 2 is mounted to a mounting portion 22, which is provided to the case 21 and projects to a side. The mounting portion 22 is provided projecting orthogonally to a side wall portion 24 from a corner portion at which a front wall portion 23 and the side wall portion 24 intersect, the front wall portion 23 being positioned forward of a housing space of the relay optical system 7, the side wall portion 24 being positioned side of the housing space. The red color laser light source apparatus 3 is mounted on an external surface side of the side wall portion 24 in a state being held by a holder 25. The blue color laser light source apparatus 4 is mounted on an external surface side of the front wall portion 23 in a state being held by a holder 26.

The red color laser light source apparatus 3 and the blue color laser light source apparatus 4 are provided in a commonly-called can package, in which a laser chip emitting laser light is disposed, such that an optical axis is positioned on a central axis of a can-shaped external mounting portion when the laser chip is supported by a stem. The laser light is emitted through a glass window provided to an opening of the external mounting portion. The red color laser light source apparatus 3 and the blue color laser light source apparatus 4 are press-fitted into attachment holes 27 and 28, respectively, which are provided to the holders 25 and 26, respectively. The red color laser light source apparatus 3 and the blue color laser light source apparatus 4 are thus fixed to the holders 25 and 26, respectively. Heat generated by the laser chips of the blue color laser light source apparatus 4 and the red color laser light source apparatus 3 is transferred through the holders 25 and 26 to the case 21 and dissipated. The holders 25 and 26 are formed of a high thermal conductive material, such as aluminum and copper.

The green color laser light source apparatus 2 includes a semiconductor laser 31; an FAC (fast-axis collimator) lens 32; a rod lens 33; a laser medium 34; a wavelength conversion element 35; a concave mirror 36; a glass cover 37; a base 38 supporting the components; and a cover body 39 covering the components. The semiconductor laser 31 emits excitation laser light. The FAC lens 32 is a collecting lens that collects the excitation laser light emitted from the semiconductor laser 31. The laser medium 34 emits fundamental laser light (infrared laser light) excited by the excitation laser light. The wavelength conversion element 35 converts a wavelength of the fundamental laser light and emits half wavelength laser light (green color laser light). The concave mirror 36 constitutes a resonator with the laser medium 34. The glass cover 37 prevents leak of the excitation laser light and fundamental wavelength laser light.

The base 38 of the green color laser light source apparatus 2 is fixed to the mounting portion 22 of the case 21. A space having a predetermined width (0.5 mm or less, for example) is provided between the green color laser light source apparatus 2 and the side wall portion 24 of the case 21. Thereby, the heat of the green color laser light source apparatus 2 is difficult to be transferred to the red color laser light source apparatus 3. The temperature of the red color laser light source apparatus 3 is then prevented from being increased. The red color laser light source apparatus 3 having undesirable temperature properties, can thus be operated stably. Further, in order to secure a predetermined margin for optical axis adjustment (approximately 0.3 mm, for example) of the red color laser light source apparatus 3, a space having a predetermined width (0.3 mm or more, for example) is provided between the green color laser light source apparatus 2 and the red color laser light source apparatus 3.

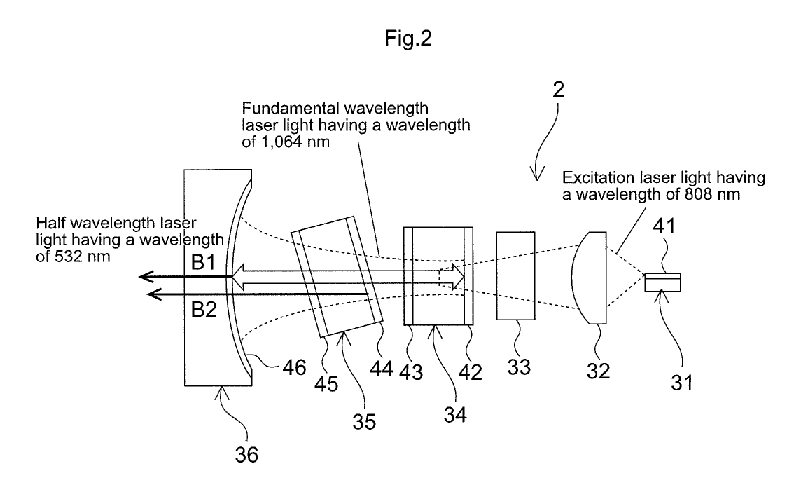

FIG. 2 is a schematic view illustrating a state of laser light in the green color laser light source apparatus 2. A laser chip 41 of the semiconductor laser 31 emits excitation laser light having a wavelength of 808 nm. The FAC lens 32 reduces expansion of a fast axis of the laser light (direction orthogonal to an optical axis direction and along a paper surface of the drawing). The rod lens 33 reduces expansion of a slow axis of the laser light (direction orthogonal to a paper surface of the drawing).

The laser medium 34, which is a commonly-called solid laser crystal, is excited by the excitation laser light having a wavelength of 808 nm and having passed through the rod lens 33, and emits fundamental wavelength laser light having a wavelength of 1,064 nm (infrared laser light). The laser medium 34 is an inorganic optically active substance (crystal) formed of, such as Y (yttrium) and VO₄ (vanadate), which is doped with Nd (neodymium). More specifically, Y of YVO₄ as a base martial is substituted and doped with Nd⁺³, which is an element producing fluorescence.

A film 42 is provided to the laser medium 34 on a side opposite to the rod lens 33, the film 42 preventing reflection of the excitation laser light having a wavelength of 808 nm and highly reflecting the fundamental wavelength laser light having a wavelength of 1,064 nm and the half wavelength laser light having a wavelength of 532 nm. A film 43 is provided to the laser medium 34 on a side opposite to the wavelength conversion element 35, the film 43 preventing reflection of the fundamental wavelength laser light having a wavelength of 1,064 nm and the half wavelength laser light having a wavelength of 532 nm.

The wavelength conversion element 35, which is a commonly-called SHG (Second Harmonics Generation) element, converts a wavelength of the fundamental wavelength laser light (infrared laser light) having a wavelength of 1,064 nm emitted from the laser medium 34, and generates the half wavelength laser light (green color laser light) having a wavelength of 532 nm. The wavelength conversion element 35 has a cyclic polarization-inverted structure, in which an inverted polarization region and a non-inverted polarization region are alternately formed on a ferroelectric crystal. The wavelength conversion element 35 allows the fundamental wavelength laser light to enter in a cyclic direction of polarization inversion (array direction of the inverted polarization region). The ferroelectric crystal may have LN (lithium niobate) added with MgO, for example.

A film 44 is provided to the wavelength conversion element 35 on a side opposite to the laser medium 34, the film 44 preventing reflection of the fundamental wavelength laser light having a wavelength of 1,064 nm and highly reflecting the half wavelength laser light having a wavelength of 532 nm. A film 45 is provided to the wavelength conversion element 35 on a side opposite to the concave mirror 36, the film 45 preventing reflection of the fundamental wavelength laser light having a wavelength of 1,064 nm and the half wavelength laser light having a wavelength of 532 nm.

The concave mirror 36 has a concave surface on a side opposite to the wavelength conversion element 35. The concave surface is provided with a film 46 highly reflecting the fundamental wavelength laser light having a wavelength of 1,064 nm and preventing reflection of the half wavelength laser light having a wavelength of 532 nm. Thereby, the fundamental wavelength laser light having a wavelength of 1,064 nm is resonated and amplified between the film 42 of the laser medium 34 and the film 46 of the concave mirror 36.

The wavelength conversion element 35 converts a portion of the fundamental wavelength laser light having a wavelength of 1,064 nm entering from the laser medium 34, to the half wavelength laser light having a wavelength of 532 nm. A portion of the fundamental wavelength laser light having a wavelength of 1,064 nm which is not converted and transmits the wavelength conversion element 35 is reflected by the concave mirror 36. The reflected fundamental wavelength laser light then re-enters the wavelength conversion element 35 and is converted to the half wavelength laser light having a wavelength of 532 nm. The half wavelength laser light having a wavelength of 532 nm is reflected by the film 44 of the wavelength conversion element 35 and emitted from the wavelength conversion element 35.

A laser beam B1 enters the wavelength conversion element 35 from the laser medium 34, is converted to a different wavelength at the wavelength conversion element 35, and is emitted from the wavelength conversion element 35. A laser beam B2 is once reflected by the concave mirror 36, enters the wavelength conversion element 35, is reflected by the film 44, and is emitted from the wavelength conversion element 35. When the laser beam B1 and the laser beam B2 interfere, the output is reduced. The wavelength conversion element 35 is thus inclined relative to an optical axis direction so as to cause refraction, which prevents interference between the laser beams B1 and B2, and thereby prevents reduction in output.

In order to prevent external leakage of the excitation laser light having a wavelength of 808 nm and the fundamental wavelength laser light having a wavelength of 1,064 nm, a film not transmitting such laser light is provided to the glass cover 37 shown in FIG. 1.

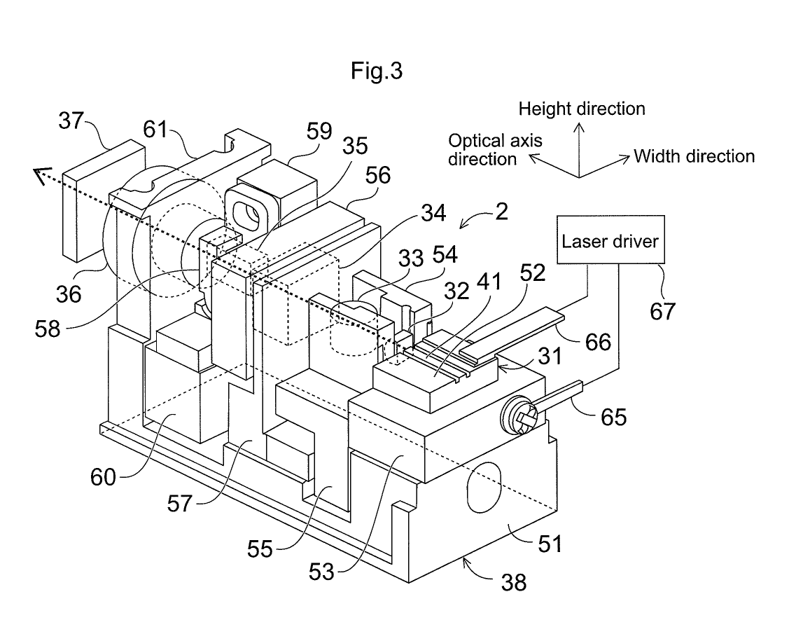

FIG. 3 is a perspective view of the green color laser light source apparatus 2. The semiconductor laser 31, the FAC lens 32, the rod lens 33, the laser medium 34, the wavelength conversion element 35, and the concave mirror 36 are integrally supported by the base 38. A bottom surface 51 of the base 38 is provided in parallel with the optical axis direction. A direction orthogonal to the bottom surface 51 of the base 38 is defined herein as a height direction; and a direction orthogonal to the height direction and the optical axis direction is defined as a width direction. The height direction is not necessarily a vertical direction.

The semiconductor laser 31 has the laser chip 41 mounted on a mounting member 52, the laser chip 41 emitting laser light. The laser chip 41 has a long band shape in the optical axis direction. The laser chip 41 is fixedly attached to substantially a central position in the width direction on one surface of the flat plate-shaped mounting member 52, in a state in which a light emitting surface faces toward the FAC lens 32. The semiconductor laser 31 is fixed to the base 38 through a mounting member 53.

The FAC lens 32 and the rod lens 33 are held by a collecting lens holder 54. The collecting lens holder 54 is fixed to the base 38 through a support member 55. The collecting lens holder 54 is connected to the support member 55 so as to be movable in the optical axis direction. Further, the support member 55 is connected to the base 38 so as to be movable in the height direction. Thus, a position of the collecting lens holder 54, specifically the FAC lens 32 and the rod lens 33, is adjusted in the height direction and the optical axis direction. Before the position is adjusted, the FAC lens 32 and the rod lens 33 are fixed with an adhesive agent to the collecting lens holder 54. After the position is adjusted, the collecting lens holder 54, the support member 55, and the base 38 are fixed to one another with an adhesive agent.

The laser medium 34 is held by a laser medium holder 56. The laser medium holder 56 is fixed to the base 38 through a support member 57.

The wavelength conversion element 35 is held by a wavelength conversion element holder 58. The wavelength conversion element holder 58 is fixed to the base 38 through a first support member 59 and a second support member 60. The wavelength conversion element holder 58 is connected to the first support member 59 so as to be inclinable. Thus, an inclination angle of the wavelength conversion element holder 58, specifically the wavelength conversion element 35, is adjusted. The first support member 59 is connected to the second support member 60 so as to be movable in the width direction. The second support member 60 is connected to the base 38 so as to be movable in the height direction. Thereby, a position of the wavelength conversion element holder 58, specifically the wavelength conversion element 35, is adjusted in the height direction and the width direction. Before the position is adjusted, the wavelength conversion element 35 is fixed with an adhesive agent to the wavelength conversion element holder 58. After the position is adjusted, the wavelength conversion element holder 58, the first support member 59, the second support member 60, and the base 38 are fixed to one another with an adhesive agent.

The concave minor 36 is held by a holder 61 integrally provided to the base 38. The glass cover 37 is held by the cover body 39 shown in FIG. 1.

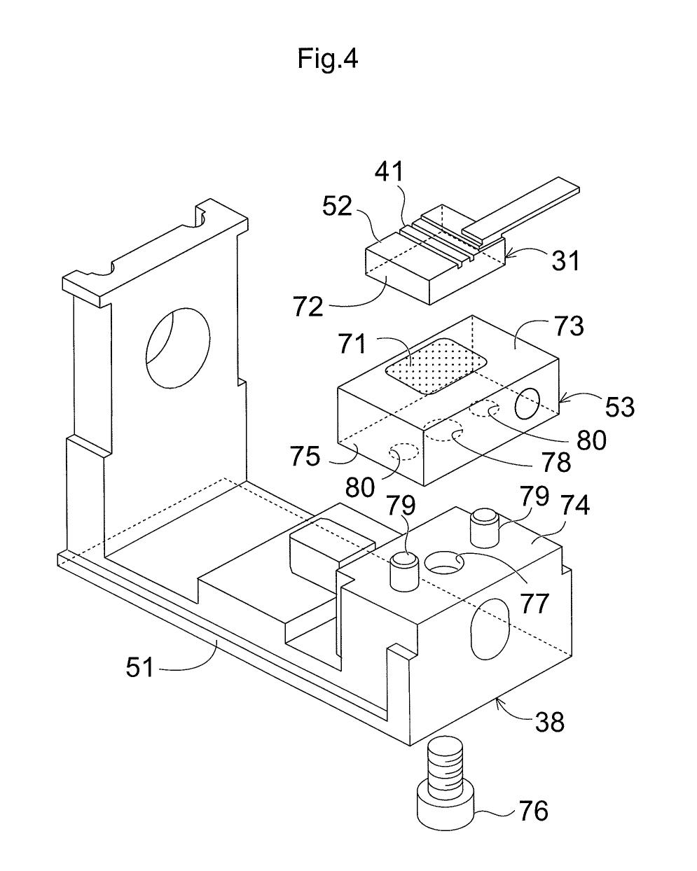

FIG. 4 is an exploded perspective view of the semiconductor laser 31, the mounting member 53, and the base 38 in the green color laser light source apparatus 2. The semiconductor laser 31, which is a very small component, is difficult to be screwed to the base 38. Thus, the semiconductor laser 31 and the mounting member 53 are fixedly attached with an adhesive agent. Heat-cured silver paste 71 is used, in particular, as the adhesive agent herein. The silver paste 71 includes silver powder, thermosetting binder resin, and a solvent. One-component epoxy resin may be employed, for example, as the binder resin, the one-component epoxy resin being cured through curing reaction by a curing agent. A curing temperature causing curing reaction in the silver paste 71 is approximately 180° C. The curing temperature of the silver paste 71 is a temperature at a time of adhesion (namely, adhesion temperature). When the semiconductor laser 31 and the mounting member 53 are adhered with the silver paste 71, the silver paste 71 is heated up to the curing temperature.

The silver paste 71, which provides a good workability, improves efficiency in an assembly process. Further, the binder resin (epoxy resin) provides high adhesiveness. Thus, the semiconductor laser 31 and the mounting member 53 are securely attached, and the semiconductor laser 31 can be prevented from being disengaged.

The base 38 is a die-cast product formed of a zinc alloy for die-casting (ZDC2). The zinc alloy for die-casting is relatively inexpensive and highly productive with a low melt point (387° C.). Further, the zinc alloy for die-casting allows production of a complex shape at a high accuracy. On the other hand, the zinc alloy for die-casting has a characteristic causing plastic deformation (creep) at a relatively low temperature of 130° C., for instance. When being exposed to a high temperature exceeding the upper temperature limit, the zinc alloy for die-casting deteriorates accuracy of mounting of members supported by the base 38, including the semiconductor laser 31.

The base 38 may be formed by commonly-called metal powder injection molding (metal injection), in which zinc alloy powder for die-casting and binder resin are mixed and injection-molded. In addition to the zinc alloy for die-casting, an aluminum alloy for die-casting and the like may be used as the material to form the base 38.

The mounting member 53 is formed by pressing a plate material formed of a metal material (for example, copper, aluminum, and the like), for example. Thereby, production of the mounting member 53 is easy, and thus manufacturing cost can be reduced. The box-shaped mounting member 53 is provided with a mounting surface 73 and a bottom surface 75 in parallel, the mounting surface 73 being contacted with a bottom surface 72 of the semiconductor laser 31 through the silver paste 71, the bottom surface 75 being contacted with a support surface 74 of the base 38. Further, the support surface 74 of the base 38 is provided in parallel with the bottom surface 51, and thus the laser chip 41 is disposed in parallel with the bottom surface 51 of the base 38.

As described hereinafter, the mounting member 53 increases heat dissipation performance by releasing heat of the semiconductor laser 31 to the base 38 through the mounting member 53. It is thus preferred that the mounting member 53 be formed of a metal material having a low heat resistance, such as, for example, copper, aluminum, or an alloy including the materials as a main ingredient. The mounting member 53 does not need to be formed by pressing a plate material as described above, but may be formed by machining.

The mounting member 53 is screwed and fixed to the base 38. The mounting member 53 is fastened to the base 38 by a screw 76, in particular herein. The screw 76 is inserted through a through-hole 77 from the bottom surface 51 side of the base 38, and screwed into a screw hole 78 provided to the mounting member 53. A projection 79 is provided to the support surface 74 of the base 38. Fitting the projection 79 to a hole 80 provided to the mounting member 53 allows positioning of the mounting member 53 relative to the base 38.

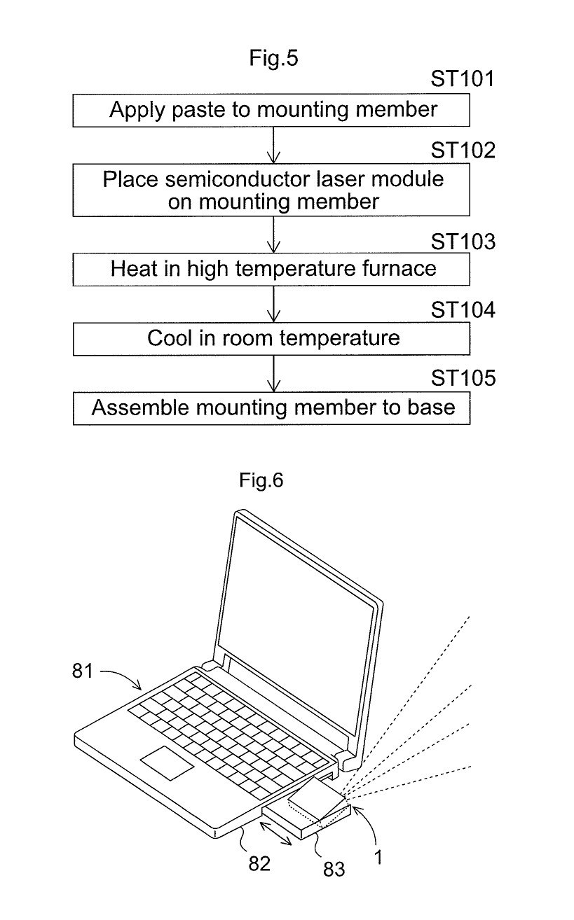

FIG. 5 illustrates an assembly procedure of the semiconductor laser 31, the mounting member 53, and the base 38. In the procedure, the silver paste 71 is applied to the mounting surface 73 of the mounting member 53 (ST101 of FIG. 5). The semiconductor laser 31 is placed on the mounting surface 73 of the mounting member 53 on which the silver paste 71 is applied as shown in FIG. 4 (ST102 of FIG. 5). Curing is then performed in which heating is performed in a high-temperature furnace in a state in which the semiconductor laser 31 is placed on the mounting member 53 (ST103 of FIG. 5). The curing is performed at a temperature of 180° C. for 2 hours, for example. After cooling is performed by leaving the components in a room temperature (ST104 of FIG. 5), the mounting member 53 is screwed and assembled to the base 38 as shown in FIG. 4 (ST105 of FIG. 5).

As described above, the semiconductor laser 31 is fixedly attached to the mounting member 53 by the silver paste 71, and then the mounting member 53 is fixed to the base 38. Thus, the base 38 can be prevented from being exposed to a high temperature in an attachment process of the silver paste 71. Thereby, even when the base 38 is formed of a die-cast material (zinc alloy for die-casting) having a lower heat resistance than the curing temperature (namely, an adhesion temperature of 180° C., for example) of the silver paste 71, dimension accuracy of the base 38 is not deteriorated.

The silver paste 71 has a lower curing temperature (namely, an adhesion temperature of 180° C., for example) than an assurance temperature (250° C., for example) of the semiconductor laser 31. Further, the mounting member 53 has a higher heat resistance than the curing temperature of the silver paste 71. Thus, the semiconductor laser 31 can be prevented from being subject to thermal damage in the process of attaching the semiconductor laser 31 to the mounting member 53 using the silver paste 71. Further, even when the mounting member 53 has a higher temperature than the curing temperature of the silver paste 71, dimension accuracy of the mounting member 53 is not deteriorated.

As shown in FIG. 3, a lead (conductive body) 65 is connected to the mounting member 53, the lead 65 supplying power to the laser chip 41 through an adhesive layer of the mounting member 53 and the silver paste 71. An electrode supplying power to the laser chip 41 is provided to a lower surface side of a mount member 52 of the semiconductor laser 31. The electrode is electrically connected to the mounting member 53 through the adhesive layer of the silver paste 71. Meanwhile, a lead 66 supplying power to the laser chip 41 is provided to an upper side of the semiconductor laser 31. A driving voltage supplied from a laser driver 67 is applied to the laser chip 41 through the leads 65 and 66.

The mounting member 53 is formed of a metal material having a low electric resistance, such as copper and aluminum. Further, the adhesive layer of the silver paste 71 provided between the mounting member 53 and the semiconductor laser 31 has a low electric resistance due to silver powder included in the silver paste 71. Thus, energization loss can be minimized.

When power is supplied to the laser chip 41 of the semiconductor laser 31, heat generated at the laser chip 41 is transferred to the mount member 52, and then to the base 38 through the adhesive layer of the silver paste 71 and the mounting member 53. The adhesive layer of the silver paste 71 has a low heat resistance due to silver powder included in the silver paste 71. Further, the mounting member 53 is formed of a metal material having a low heat resistance, such as copper and aluminum. Thus, the heat from the semiconductor laser 31 can effectively be dissipated.

The heat transferred to the base 38 is transferred from the bottom surface 51 of the base 38 to the mounting portion 22 of the case 21 shown in FIG. 1, and is dissipated in the air. In order to effectively dissipate the heat from the base 38, a member facilitating cooling, such as a heatsink, may be attached to a heat dissipation surface of the base 38 and the mounting portion 22.

The silver paste 71 has a higher curing temperature (namely, an adhesion temperature of 180° C., for example) than an operation temperature (100° C., for example) of the semiconductor laser 31. The heat resistance temperature of the silver paste 71 is higher than the operation temperature of the semiconductor laser 31. Thus, the silver paste 71 is not heated over the heat resistance temperature during operation of the green color laser light source apparatus 2. Further, the mounting member 53 has a higher heat resistance than the operation temperature of the semiconductor laser 31. Thus, accuracy of mounting of the semiconductor laser 31 is not deteriorated, and the semiconductor laser 31 is not disengaged, due to heating during operation.

FIG. 6 is a perspective view illustrating an example in which the image display apparatus 1 is installed in a laptop information processing apparatus 81. A space to slidably store the image display apparatus 1 is provided to a body 82 of the image display apparatus 1 on a rear side of a keyboard. When being not used, the image display apparatus 1 is stored in the body 82. When being used, the image display apparatus 1 is pulled out of the body 82, and rotated by a predetermined angle relative to a base 83 that rotatably supports the image display apparatus 1. Thereby, the laser light from the image display apparatus 1 can be projected on the screen.

In the embodiment above, the silver paste is used as the adhesive material to attach the semiconductor laser 31 and the mounting member 53. However, the present invention is not limited to the material. Other adhesive agents may be employed using particles other than silver powder having thermal conductivity and electrical conductivity, such as metal powder and carbon. Further, the adhesive material of the present intention is not limited to the paste form. Specifically, an adhesive sheet may be employed, which is formed of particles having thermal conductivity and electrical conductivity and binder resin and is previously formed into a film. As long as a material has heat resistance which is resistant to softening or weakening at the operation temperature of the semiconductor laser 31, a thermally melt-type adhesive material using thermoplastic resin may be employed in addition to the thermosetting adhesive material.

The laser light source apparatus according to the present invention has an effect to reduce the manufacturing cost of the base that supports the semiconductor laser, without deteriorating the accuracy of mounting of the semiconductor laser. The laser light source apparatus is effective as a laser light source apparatus used as a light source for the image display apparatus

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

The present invention is not limited to the above described embodiments, and various variations and modifications may be possible without departing from the scope of the present invention.

What is claimed is:

1. A laser light source apparatus comprising:
a semiconductor laser emitting laser light;
a base supporting the semiconductor laser; and
a mounting member provided between the base and the semiconductor laser, wherein
the semiconductor laser and the mounting member are fixedly attached by a thermally adhesive material; and
the adhesive material has a lower adhesion temperature than an assurance temperature of the semiconductor laser and a higher heat resistance than an operation temperature of the semiconductor laser.

2. The laser light source apparatus according to claim 1, wherein the mounting member is formed of a material having a higher heat resistance than the adhesion temperature of the adhesive material.

3. The laser light source apparatus according to claim 1, wherein the adhesive material is silver paste including silver powder, binder resin, and a solvent.

4. The laser light source apparatus according to claim 3, wherein the binder resin is epoxy resin cured through curing reaction by a curing agent.

5. The laser light source apparatus according to claim 3, wherein a curing temperature that causes the curing reaction in the silver paste is 180 degrees.

6. The laser light source apparatus according to claim 1, wherein the base is formed of a zinc ally for die-casting.

7. The laser light source apparatus according to claim 1, wherein
the mounting member and the adhesive material have conductivity; and
a conductive body is connected to the mounting member, the conductive body supplying power to the semiconductor laser through the mounting member and the adhesive material.

8. The laser light source apparatus according to claim 1, wherein the semiconductor laser emits excitation laser light, and comprises:
a laser medium emitting infrared laser light excited by the excitation laser light emitted from the semiconductor laser; and
a wavelength conversion element converting a wavelength of the infrared laser light emitted from the laser medium and emitting green color light laser light.

9. The laser light source apparatus according to claim 8, wherein the laser medium and the wavelength conversion element are integrally supported by the base along with the semiconductor laser.

10. An image display apparatus having the laser light source apparatus according to claim 1.

11. An image display apparatus having the laser light source apparatus according to claim 9.

12. The image display apparatus according to claim 10, wherein the apparatus is slidably stored in a laptop information processing apparatus.

13. The image display apparatus according to claim 12, wherein the apparatus is stored in a body of the laptop information processing apparatus when being not used, and is pulled out from the body when being used.
